(19) United States
(12) Patent Application Publication
(10) Pub. No.: US 2024/0078275 A1
(43) Pub. Date: Mar. 7, 2024

(54) METHOD AND DEVICE FOR DISPLAYING INFORMATION IN APPLICATION

(71) Applicant: BEIJING ZITIAO NETWORK TECHNOLOGY CO., LTD., Beijing (CN)

(72) Inventors: Hao HU, Beijing (CN); Junping WANG, Beijing (CN); Biao ZHENG, Beijing (CN); Yulin DENG, Beijing (CN); Peize TONG, Beijing (CN)

(21) Appl. No.: 18/262,350

(22) PCT Filed: Feb. 23, 2022
(86) PCT No.: PCT/CN2022/077363

§ 371 Date: Jul. 20, 2023

(30) Foreign Application Priority Data
Apr. 30, 2021 (CN) 202110486256.8

(51) Int. Cl. G06F 16/9538; G06F 3/14

(52) U.S. Cl. CPC G06F 16/9538; G06F 3/14

(57) ABSTRACT

Disclosed in embodiments of the present application is a method for displaying information in an application. A provider creates flowable information to be displayed by means of a data standard provided by a sharing platform, and provides same to the sharing platform. When one party (a display party) is to present information of another party (a provider party), the display party sends a display request to the sharing platform, the display request comprising an identifier of information to be displayed. Upon receiving the display request, the sharing platform acquires the information to be displayed according to the identifier in the display request, so that the display party can display the information to be displayed. Therefore, by means of the technical solution provided in the embodiments of the present application, if there are a plurality of display parties, each display party can display the information to be displayed provided by the provider party without performing data communication negotiations with the provider party, thereby reducing resources occupied by communication negotiations and improving information interaction efficiency.

The present disclosure is a national stage of International Application No. PCT/CN2022/077363, filed on Feb. 23, 2022, which claims priority to Chinese Patent Application No. 202110486256.8, titled “METHOD AND DEVICE FOR DISPLAYING INFORMATION IN APPLICATION”, filed on Apr. 30, 2021 with the China National Intellectual Property Administration, both of which are incorporated herein by reference in their entireties.

### FIELD

The present disclosure relates to the technical field of computer processing, and in particular to a method and a device for displaying information in an application.

### BACKGROUND

With the emergence of various applications, there are some scenarios of information interaction between various applications. However, information required to be transferred between different applications lacks a unified definition, which results in that information cannot be transferred normally between different applications. In some scenarios, a negotiation is performed between different applications, and information can be transferred after the negotiation is successful. When information interaction is performed between an application and multiple other applications, the negotiation needs to be performed between the application and each of the multiple other applications, which reduces the efficiency of information interaction.

### SUMMARY

In view of this, a method and a device for displaying information in an application are provided according to the embodiments of the present disclosure, to realize free transfer of information among multiple applications, thereby improving the efficiency of information interaction.

To solve the above problem, the following technical solutions are provided according to the embodiments of the present disclosure.

In a first aspect, a method for displaying information in an application is provided according to an embodiment of the present disclosure. The method includes: receiving, by a sharing platform, a display request sent by a display application, where the display request includes an identifier of to-be-displayed information, the to-be-displayed information is generated by a provider application based on a data standard of the sharing platform, and the data standard indicates a field to be displayed in the to-be-displayed information; and obtaining, by the sharing platform, the to-be-displayed information according to the identifier.

In an implementation, the obtaining, by the sharing platform, the to-be-displayed information according to the identifier includes: searching out and obtaining, by the sharing platform, the to-be-displayed information locally according to the identifier; or sending, by the sharing platform, a request message for obtaining the to-be-displayed information to the provider application according to the identifier, and receiving, by the sharing platform, a response message sent by the provider application, where the response message includes the to-be-displayed information.

In an implementation, the method further includes: providing, by the sharing platform, a display carrier to the display application in response to the display application loading the sharing platform, to display the to-be-displayed information through the display carrier on the display application.

In an implementation, a display component corresponding to the to-be-displayed information is provided, and the display component indicates a way for displaying the to-be-displayed information.

In an implementation, the display carrier provided by the sharing platform is configured to provide an operating environment for the display component.

In an implementation, the method further includes: receiving, by the sharing platform, a notification message sent by the provider application, in a case that the to-be-displayed information corresponding to the identifier changes, where the notification message includes the identifier.

In an implementation, the notification message further includes updated to-be-displayed information.

In an implementation, after the sharing platform receives the notification message, the method further includes: determining, by the sharing platform, whether the to-be-displayed information corresponding to the identifier is in a presented status; obtaining, by the sharing platform, the updated to-be-displayed information in response to the to-be-displayed information corresponding to the identifier being in the presented status, to display the updated to-be-displayed information by the display application.

In an implementation, the method further includes: storing, by the sharing platform, the updated to-be-displayed information locally.

In an implementation, the data standard indicates a type corresponding to the field.

In a second aspect, a method for displaying information in an application is provided according to an embodiment of the present disclosure. The method includes: obtaining, by a display application, to-be-displayed information through a sharing platform in response to a triggering operation of a user, where the to-be-displayed information is generated by the provider application based on a data standard of the sharing platform, and the data standard indicates a field to be displayed in the to-be-displayed information; and displaying, by the display application, the to-be-displayed information.

In an implementation, the obtaining, by a display application, to-be-displayed information through a sharing platform includes: sending, by the display application, a display request to the sharing platform, where the display request includes an identifier of the to-be-displayed information, to cause the sharing platform to search out the to-be-displayed information locally or request the to-be-displayed information from the provider application according to the identifier of the to-be-displayed information.

In an implementation, the displaying, by the display application, the to-be-displayed information includes: displaying, by the display application, the to-be-displayed information according to a display component corresponding to the to-be-displayed information, where the display component indicates a way for displaying the to-be-displayed information, and the display component is provided by the provider application.

In an implementation, the displaying, by the display application, the to-be-displayed information includes: loading, by the display application, a display carrier; and displaying, by the display application, the to-be-displayed information based on the display carrier, where the display carrier is provided by the sharing platform and is configured to display the to-be-displayed information.

In an implementation, the to-be-displayed information has an expansion capability, where the expansion capability indicates an operation which is available for the to-be-displayed information by the user.

In an implementation, the expansion capability is coupled with the display application.

In an implementation, the expansion capability is decoupled from the display application.

In an implementation, the method further includes: outputting, by the display application, an extension control corresponding to the extension capability or an extension result corresponding to the extension capability, in response to a triggering operation of the user for the to-be-displayed information.

In an implementation, the extension capability indicates a capability of adding a label to the to-be-displayed information or a capability of commenting on the to-be-displayed information.

In an implementation, the method further includes: entering a label adding page, in response to a triggering operation of the user on a label control of the to-be-displayed information; and receiving, by the display application, label information inputted by the user on the label adding page, and displaying the to-be-displayed information and added label information in an association manner.

In an implementation, the method further includes: entering a comment page, in response to a triggering operation of the user on a comment control of the to-be-displayed information; and receiving, by the display application, comment content inputted by the user on the comment page, and displaying the to-be-displayed information and the comment content in an association manner.

In a third aspect, a method for displaying information in an application is provided according to an embodiment of the present disclosure. The method includes: generating, by the provider application, to-be-displayed information based on a data standard provided by a sharing platform, where the data standard indicates a field to be displayed in the to-be-displayed information; determining, by the provider application, whether to cache the to-be-displayed information on the sharing platform; and sending, by the provider application, the to-be-displayed information to the sharing platform in response to determining to cache the to-be-displayed information on the sharing platform.

In an implementation, after the generating, by the provider application, to-be-displayed information based on a data standard provided by a sharing platform, the method further includes: encapsulating, by the provider application, an expansion capability for the to-be-displayed information.

In an implementation, the expansion capability is coupled with the display application.

In an implementation, the expansion capability is decoupled from the display application.

In an implementation, the provider application stores a correspondence between the expansion capability and the display application.

In a fourth aspect, a system for displaying information in an application is provided according to an embodiment of the present disclosure. The system includes an interaction object and a sharing platform. The sharing platform is configured to provide a data standard, to cause the interaction object to generate to-be-displayed information based on the data standard. The data standard indicates a field to be displayed in the to-be-displayed information. The sharing platform is further configured to provide the to-be-displayed information to the interaction object according to a display request sent by the interaction object. The display request includes an identifier of the to-be-displayed information.

In an implementation, the sharing platform includes a data management module and a display carrier.

In an implementation, the data management module interacts with the interaction object.

In an implementation, the data management module is further configured to store the to-be-displayed information.

In an implementation, the display carrier is configured to display the to-be-displayed information at a preset position of the interaction object based on loading of the interaction object.

In an implementation, when the to-be-displayed information changes, the data management module is further configured to receive a notification message sent by the interaction object, where the notification message includes the identifier.

In an implementation, the data management module is further configured to determine whether to-be-displayed information corresponding to the identifier is in a presented status, and send an updating message to the display carrier in response to the to-be-displayed information corresponding to the identifier being in the presented status. The updating message includes the identifier. The display carrier is configured to call back updated to-be-displayed information and display the updated to-be-displayed information to the interaction object.

In an implementation, the interaction object is a display application or a provider application. The display application is configured to display the to-be-displayed information, and the provider application is configured to provide the to-be-displayed information.

In a fifth aspect, a device for displaying information in an application is provided according to an embodiment of the present disclosure. The device includes a receiving unit and an obtaining unit. The receiving unit is configured to receive a display request sent by a display application. The display request includes an identifier of the to-be-displayed information. The to-be-displayed information is generated by the provider application based on a data standard of a sharing platform. The data standard indicates a field to be displayed in the to-be-displayed information. The obtaining unit is configured to obtain the to-be-displayed information according to the identifier.

In a sixth aspect, a device for displaying information in an application is provided according to an embodiment of the present disclosure. The device includes an obtaining unit and a display unit. The obtaining unit is configured to obtain to-be-displayed information through a sharing platform, in response to a triggering operation of a user. The to-be-displayed information is generated by a provider application based on a data standard of the sharing platform. The data standard indicates a field to be displayed in the to-be-displayed information. The display unit is configured to display the to-be-displayed information.

In a seventh aspect, a device for displaying information in an application program is provided according to an embodiment of the present disclosure. The device includes a generation unit, a determination unit, and a sending unit. The generation unit is configured to generate to-be-displayed information based on a data standard provided by a sharing platform. The data standard indicates a field to be displayed in the to-be-displayed information. The determination unit is configured to determine whether to cache the to-be-displayed information on the sharing platform. The sending unit is configured to send the to-be-displayed information to the sharing platform in response to determining to cache the to-be-displayed information on the sharing platform.

In an eighth aspect, an electronic device is provided according to an embodiment of the present disclosure. The electronic device includes one or more processors, and a memory. The memory stores one or more programs. The one or more programs, when executed by the one or more processors, cause the one or more processors to implement the method for displaying information in the application according to the first aspect, the second aspect, or the third aspect.

In a ninth aspect, a computer-readable storage medium is provided according to an embodiment of the present disclosure. The computer-readable storage medium stores instructions. The instructions, when executed by a device, cause the device to implement the method for displaying information in the application according to the first aspect, the second aspect, or the third aspect.

In a tenth aspect, a computer program product is provided according to an embodiment of the present disclosure. The computer program product includes a computer program carried on a non-transient computer-readable medium. The computer program includes program codes for implementing the method for displaying information in the application according to the first aspect, the second aspect, or the third aspect.

It can be seen that the embodiments of the present disclosure have the following beneficial effects.

A sharing platform is provided in the technical solutions according to the embodiments of the present disclosure. A provider application creates transferable to-be-displayed information through a data standard provided by the sharing platform, and provides the to-be-displayed information to the sharing platform. When an application (the display application) desires to display information from other application (the provider application), the display application sends a display request to the sharing platform. The display request includes an identifier of the to-be-displayed information. The sharing platform, after receiving the display request, obtains the to-be-displayed information according to the identifier in the display request, so that the display application displays the to-be-displayed information. With the technical solutions according to the embodiments of the present disclosure, in the case that there are multiple display applications, the to-be-displayed information provided by the provider application can be displayed without data communication negotiation between each of the multiple display applications and the provider application, which reduces the resources occupied by the communication negotiation and improves the efficiency of information interaction.

### BRIEF DESCRIPTION OF THE DRAWINGS

FIG. 1 is a schematic diagram of information interaction;

FIG. 2 is a schematic diagram of information interaction according to an embodiment of the present disclosure;

FIG. 3 is a schematic structural diagram of a sharing platform according to an embodiment of the present disclosure;

FIG. 4 is a schematic diagram of an application scenario according to an embodiment of the present disclosure;

FIG. 5 is a flowchart of a method for displaying information in an application according to an embodiment of the present disclosure;

FIG. 6 is a flowchart of a method for displaying information in an application according to another embodiment of the present disclosure;

FIG. 7 is a structural diagram of a system for displaying information in an application according to an embodiment of the present disclosure;

FIG. 8 is a structural diagram of a device for displaying information in an application according to an embodiment of the present disclosure;

FIG. 9 is a structural diagram of a device for displaying information in an application according to another embodiment of the present disclosure;

FIG. 10 is a structural diagram of a device for displaying information in an application according to another embodiment of the present disclosure; and

FIG. 11 is a structural diagram of an electronic device according to an embodiment of the present disclosure.

### DETAILED DESCRIPTION OF EMBODIMENTS

Hereinafter the embodiments of the present disclosure are described in further detail in combination with the drawings and specific implementations, in order to make the above objective, features and advantages of the present disclosure more obvious and understandable.

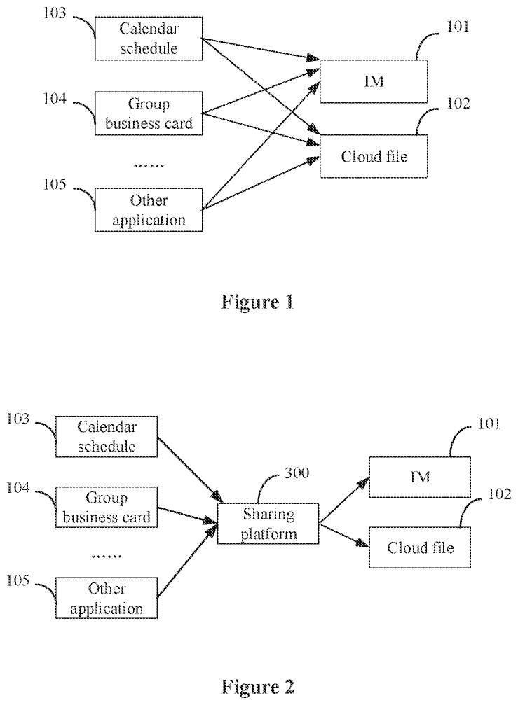

In the study of conventional information interaction, it is found that in information interaction between different applications, format of information transferred between different applications lacks a unified definition, so that data communication negotiation is required for information transfer between different applications to cause a format of data provided by a data provider application to meet display application's requirements for display. The information can be transferred only after the negotiation is successful. For example, as shown in FIG. 1, n negotiation is made between an instant messaging (IM) application 101 and a calendar schedule application 103 before the instant messaging application 101 displays information in the calendar schedule application 103. The calendar schedule application 103 provides the IM with information meeting a specification required by the IM after the negotiation is successful, so that the IM can display the information provided by the calendar schedule application 103. A negotiation is made between a cloud file application 102 and the calendar schedule application 103 before the cloud file application 102 displays information in the calendar schedule application 103, so that the calendar schedule application 103 provides the cloud file application 102 with information meeting a specification required by the cloud file application. Thus, information transfer is realized. When information is transferred among a large number of applications, a negotiation between one application and each of other applications 105 is required, and this negotiation occupies a lot of resources and results in a low efficiency of information transfer.

Based on this, a sharing platform is provided according to an embodiment of the present application. Different applications may create an information fragment that can be flexibly displayed and exchanged, based on a data standard provided by the sharing platform, to realize free transfer of information. As shown in FIG. 2, the provider application may include, for example, the calendar schedule application 103, a group business card application 104, other application 105, and the like. The provider application provides an interactive information fragment to the sharing platform 300, that is, to-be-displayed information. The display application includes the IM application 101, the cloud file 102, and the like. The display application obtains the to-be-displayed information through the sharing platform 300, to display the to-be-displayed information, without the negotiation between the provider application and the display application, which improves the efficiency of information transfer.

It should be noted that the display application and the provider application in the embodiments of the application refer to different applications. The two different applications may be independent applications serviced by different service provider sides. Alternatively, the two applications may be two different application modules that are associated with each other and serviced by the same service provider side. For example, the display application is an application on a first collaboration platform, and the provider application is an application on a second collaboration platform. The first collaboration platform and the second collaboration platform correspond to different servers respectively. Alternatively, the display application and the provider application are on the same collaboration platform. For example, the display application is an IM application on a first collaboration platform, and the provider application is a mail application or the like on the first collaboration platform.

### Method Embodiment

In order to understand the technical solutions according to the present disclosure, a sharing platform according to an embodiment of the present disclosure is described below.

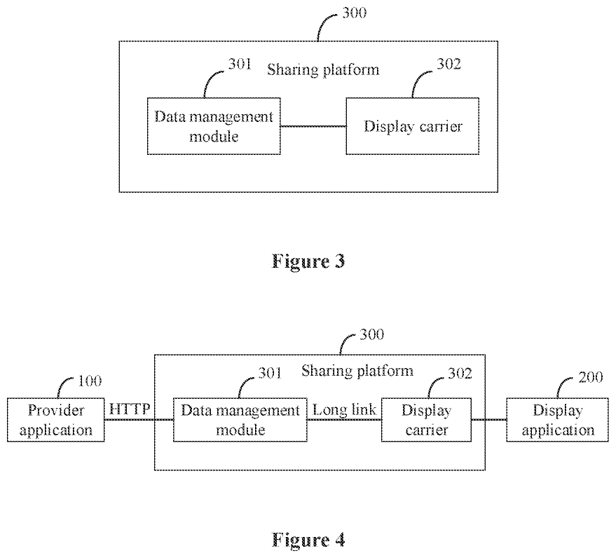

Reference is made to FIG. 3, which is a schematic structural diagram of a sharing platform according to an embodiment of the present disclosure. As shown in FIG. 3, the sharing platform 300 includes a data management module 301 and a display carrier 302.

The data management module 301 is configured to interact with different applications and manage data. The data management module 301 provides a data standard to provider applications. The data standard indicates a field required to be displayed in to-be-displayed information provided by the provider application, and may further indicate a type corresponding to the field. The provider application converts information in the provider application into data in a standard format based on the data standard. The to-be-displayed information may be a data summary or a data description provided by the provider application. The to-be-displayed information includes the field defined by the data standard. For example, the provider application is a cloud file, and the field in the to-be-displayed information provided by the provider application may include a file title, an author, a file link, permission, and the like. A field type may be a character type. Specifically, the data management module 301 is configured to receive a display request sent by the display application, and obtain to-be-displayed information corresponding to an identifier according to the identifier in the display request.

The data management module 301 may further be configured to provide a data caching capability to store the to-be-displayed information. Whether the data management module 301 is allowed to cache the to-be-displayed information is determined by the provider application. For example, if the provider application determines that the provided to-be-displayed information includes sensitive data, the provider application may determine not to cache the to-be-displayed information in the data management module. Alternatively, the provider application may determine to cache insensitive data in the to-be-displayed information in the data management module.

It can be understood that if the data management module 301 is allowed to cache the to-be-displayed information, the data management module 301 may search out and obtain the to-be-displayed information locally according to an identifier of the to-be-displayed information in the display request after receiving the display request sent by the display application. If the data management module 301 is not allowed to cache the to-be-displayed information, the data management sends a request message to the provider application to request the to-be-displayed information through the request message, after receiving the display request sent by the display application.

In an implementation, the data management module 301 is further configured to synchronize data. For example, when the to-be-displayed information changes, the provider application may send a notification message including the identifier of the to-be-displayed information to the data management module 301, to notify the data management module 301, through the notification message, that the to-be-displayed information corresponding to the identifier is updated. The notification message may further include updated to-be-displayed information.

The data management module 301, after receiving the notification message, determines whether the to-be-displayed information corresponding to the identifier is in a presented status. In the case that the to-be-displayed information is in the presented status, the data management module sends an updating message to the display carrier 302. The updating message includes an identifier. The display carrier 302, after receiving the updating message, calls back the updated to-be-displayed information to provide the updated to-be-displayed information to the display application. In the case that the to-be-displayed information corresponding to the identifier is not presented and the updated to-be-displayed information is allowed to be cached by the data management module 301, the data management module 301 updates the to-be-displayed information. In the case that the updated to-be-displayed information is not allowed to be cached by the data management module 301 and the notification message includes the updated to-be-displayed information, the updated to-be-displayed information is discarded.

For example, as shown in FIG. 4, the data management module 301 may provide an external application programming interface (API) such as an event subscription webhook interface, to support the provider application 100 to synchronize data through a hypertext transfer protocol (HTTP). In addition, an internal long link may further be established between the data management module 301 and the display carrier 302 to transmit data through the long link.

The display carrier 302 is configured to provide an environment for the display application 200 to display the to-be-displayed information. Specifically, the display carrier may be integrated in the display application 200. The display application 200 displays the to-be-displayed information by loading the display carrier.

In an implementation, the display application not only provides the to-be-displayed information, but also provides a display component corresponding to the to-be-displayed information. The display component is configured to define a form for displaying the to-be-displayed information. One piece of to-be-displayed information may correspond to one display component, to ensure that different display applications display the to-be-displayed information in the same form. Specifically, the display carrier 302 provides an operating environment for the display component.

Based on the sharing platform mentioned above, a method for displaying information in an application according to an embodiment of the present disclosure is described below in combination with the drawings.

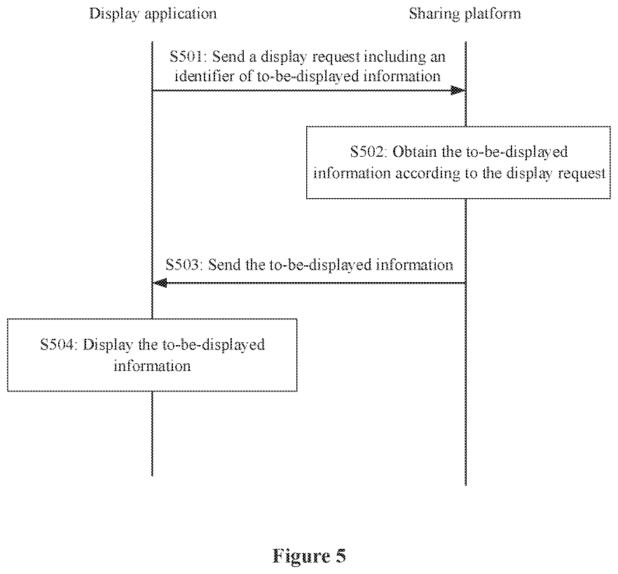

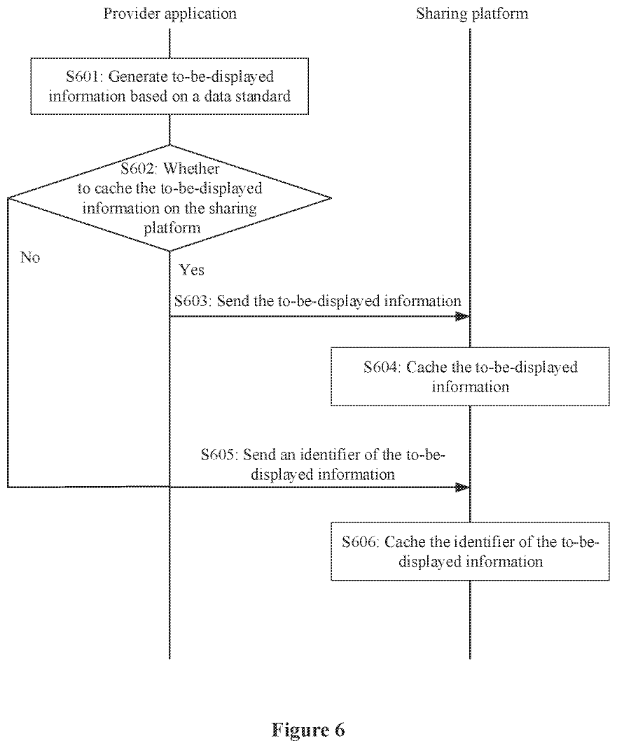

Reference is made to FIG. 5, which is a flowchart of a method for displaying information in an application according to an embodiment of the present disclosure. As shown in FIG. 5, the method includes the following steps S501 to S504.

In step S501, a display application sends a display request to a sharing platform.

In this embodiment, in response to detecting a triggering operation of a user, the display application sends a display request to the sharing platform. The display request includes an identifier (ID) of the to-be-displayed information. Specifically, since a display carrier may be integrated in the display application, the display application sends the display request to the data management module through the display carrier. For example, a display carrier of the sharing platform is integrated in a cloud file. When the user is required to display a group business card in the cloud file, the cloud file sends an ID corresponding to the group business card to the data management module of the sharing platform through the display carrier, in response to a triggering operation of the user.

In step S502, the sharing platform obtains to-be-displayed information according to the display request.

In the above embodiments, the sharing platform may have a data caching capability. The to-be-displayed information provided by provider applications may be cached into the data management module of the sharing platform. However, whether the sharing platform caches the to-be-displayed information is determined by the provider application. Based on this, the sharing platform may obtain the to-be-displayed information in the following ways.

In the case that the sharing platform stores the to-be-displayed information, the sharing platform, after obtaining a display request, searches out and obtains the to-be-displayed information corresponding to an identifier in the display request according to the identifier. When storing the to-be-displayed information, the sharing platform may further store a correspondence table between to-be-displayed information and the identifier, to query the to-be-displayed information according to the table.

In the case that the sharing platform does not stores the to-be-displayed information, after obtaining a display request, the sharing platform generates a request message based on the display request, sends the request message to the provider application, and receive a response message sent by the provider application. The response message includes to-be-displayed information. The request message includes an identifier of the to-be-displayed information. The to-be-displayed information may be generated by the provider application in advance based on the data standard provided by the sharing platform. For example, the IM may standardize the group business card at a development stage. Alternatively, the to-be-displayed information may be generated by the provider application based on the data standard when the provider application perceives a demand (for example, the provider application receives the request message). Timing of the provider application generating the to-be-displayed information can be determined according to actual applications, which is not limited here in this embodiment. The implementation of the provider application is described in the following embodiments.

In step S503, the sharing platform sends the to-be-displayed information to the display application.

In step S504, the display application displays the to-be-displayed information.

In an embodiment, since the display carrier of the sharing platform may be integrated in the display application, the data management module of the sharing platform obtains the to-be-displayed information, and sends the to-be-displayed information to the display carrier. The display carrier may display the to-be-displayed information at a preset position of the display application based on loading of the display application.

In an implementation, the provider application not only provides the to-be-displayed information, but also provides a display component matching the to-be-displayed information. The display component indicates a way for displaying the to-be-displayed information. The display component ensures that different display applications display the to-be-displayed information in a unified way. Specifically, when the display application displays to-be-displayed information, the to-be-displayed information is displayed according to a display component corresponding to the to-be-displayed information. The display carrier integrated in the display application provides an operating environment for the display component. That is, when the display application displays the to-be-displayed information, only the display carrier needs to be loaded to load the to-be-displayed information by the display carrier, rather than directly loading the to-be-displayed information. In this way, a logical isolation between the display application and the to-be-displayed information is realized, thereby improving security of the display application and the to-be-displayed information and avoiding that malicious information carried by the to-be-displayed information affects normal use of the display application.

In an implementation, the to-be-displayed information may further have an extension capability. The extension capability indicates an operation that the user can perform on the to-be-displayed information. For example, the extension capability may be a capability of adding a label to the to-be-displayed information, or a capability of commenting on the to-be-displayed information. In this embodiment, the extension capability may be divided into a general expansion capability and a personalized expansion capability based on a relationship between the expansion capability and the display application. The general expansion capability is decoupled from the display application. That is, the general expansion capability is independent of the display application. The general expansion capability can be realized in various display applications. For example, the capability of adding the label can be realized in the display applications such as the IM, the cloud file, and the calendar. For the general expansion capability, the provider application may encapsulate the general expansion capability in an outer layer of the to-be-displayed information when generating the to-be-displayed information. In a process of displaying the to-be-displayed information, the display application may output an extension component corresponding to the general extension capability or an extension result corresponding to the general extension capability. For example, when the to-be-displayed information is displayed in the IM, a label control is displayed in response to a triggering operation of the user for the to-be-displayed information. Alternatively, after a label is added to the to-be-displayed information, a name corresponding to the label may further be displayed.

In an embodiment, after the display application outputs the label control, a label adding page is entered in response to a triggering operation of the user on the label control. The display application receives label information inputted by the user on the tag adding page, and displays the to-be-displayed information the added label information in an association manner. For example, the to-be-displayed information is added to a label page indicated by the label information. The label information inputted by the user may include a label name. The label name inputted by the user may be an existing label name or a newly created label name.

The personalized expansion capability is coupled with the display application, and refers to an expansion capability “having a feature of the display application” provided by the display application. For example, a Pin function is provided by the IM in the lark suite for to-be-displayed information, and a comment function is provided by the cloud file for the to-be-displayed information. For the personalized extension capability, the provider application may encapsulate the extension capability for the to-be-displayed information in advance according to the extension capability provided by the display application. Alternatively, the provider application stores a correspondence between the personalized extension capability and a display application in advance, and encapsulates a personalized extension capability corresponding to a display application for the to-be-displayed information when perceiving a demand of the display application for the to-be-displayed information.

In an embodiment, a comment page is entered in response to a triggering operation of the user on a comment control for the to-be-displayed information. The display application receives comment content inputted by the user on the comment page, and displays the to-be-displayed information and the comment content in the association manner.

Interaction between the information provider application and the sharing platform is described below in combination with the drawings based on the above embodiments.

Reference is made to FIG. 6, which is a flowchart of a method for displaying information in an application according to another embodiment of the present disclosure. As shown in FIG. 6, the method includes the following steps S601 to S606.

In step S601, a provider application generates to-be-displayed information based on a data standard provided by a sharing platform.

In this embodiment, any application may generate the to-be-displayed information based on the data standard provided by the sharing platform. The data standard indicates a field required to be displayed in the to-be-displayed information, and may further indicate a type of the field.

In an implementation, after generating the to-be-displayed information based on the data standard, the provider application may further encapsulate an extension capability for the to-be-displayed information. The extension capability indicates an operation that the user can perform on the to-be-displayed information. The expansion capability may be coupled with the display application. That is, the expansion capability is provided by the display application. Alternatively, the expansion capability is decoupled from the display application. That is, the expansion capability is independent of the display application. Implementation of the expansion capability may refer to the relevant description in the embodiment shown in FIG. 5.

In step S602, the provider application determines whether to cache the to-be-displayed information on the sharing platform. Steps S603 and S604 are performed in the case of determining to cache the to-be-displayed information on the sharing platform, and steps S605 and S606 are performed in the case of determining not to cache the to-be-displayed information on the sharing platform.

After generating the to-be-displayed information, the provider application may determine whether to cache the to-be-displayed information on the sharing platform. In an embodiment, the provider application may determine whether to cache the to-be-displayed information, in response to determining whether the to-be-displayed information includes sensitive data. For example, in the case that the to-be-displayed information includes sensitive data, the to-be-displayed information may not be cached on the sharing platform. In the case that the to-be-displayed information does not include sensitive data, the to-be-displayed information may be cached on the sharing platform. Alternatively, in the case that the to-be-displayed information includes sensitive data, some insensitive data may be cached on the sharing platform. Specifically, in the case of the provider application determining to cache the to-be-displayed information on the sharing platform, steps S603 and S604 are performed to send the to-be-displayed information to the sharing platform. In the case of the provider application determining not to cache the to-be-displayed information on the sharing platform, steps S605 and S606 are performed to send an identifier of the to-be-displayed information to the sharing platform.

In step S603, the provider application sends the to-be-displayed information to the sharing platform.

In step S604, the sharing platform caches the to-be-displayed information.

The provider application not only sends the to-be-displayed information to the sharing platform, but also sends the identifier corresponding to the to-be-displayed information to the sharing platform. The sharing platform can store a correspondence between the identifier and the to-be-displayed information.

In step S605, the provider application sends an identifier of the to-be-displayed information to the sharing platform.

In step S606, the sharing platform stores the identifier of the to-be-displayed information.

When the sharing platform is not allowed to store the to-be-displayed information, the provider application sends the identifier of the to-be-displayed information to the sharing platform. The sharing platform stores the identifier.

It should be noted that since a display carrier of the sharing platform may be integrated in the display application, the display application may obtain the identifier of the to-be-displayed information and store the identifier. When the display application needs to display the to-be-displayed information, the to-be-displayed information may be requested through the identifier. That is, the display application only needs to store the identifier corresponding to the to-be-displayed information rather than the to-be-displayed information, which reduces occupation of a storage space of the display application.

In an implementation, when the to-be-displayed information corresponding to the identifier changes, the provider application may send a notification message to the sharing platform. The notification message includes the identifier of the to-be-displayed information.

The notification message is used for notifying the sharing platform that the to-be-displayed information corresponding to the identifier is updated. The notification message may further include updated to-be-displayed information.

In an implementation, after receiving the notification message, the sharing platform may further determine whether the to-be-displayed information corresponding to the identifier is in a presented status, and obtain updated to-be-displayed information to display the updated information for the display application, in response to the to-be-displayed information corresponding to the identifier being in the presented status. Specifically, in the case that the provider application allows the sharing platform to store the to-be-displayed information, the sharing platform may update the locally stored to-be-displayed information after receiving the notification message.

### System Embodiment

An information interaction system is provided according to an embodiment of the present disclosure based on the above embodiments. The system is described below in combination with the drawings.

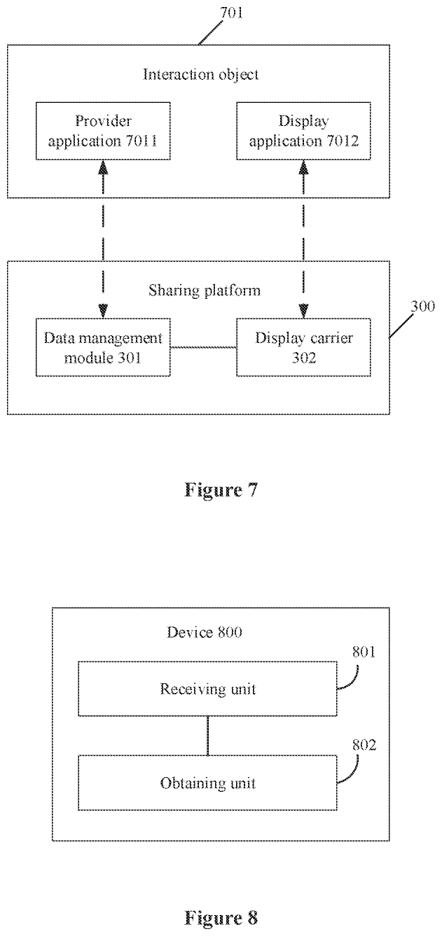

Reference is made to FIG. 7, which is a structural diagram of a system for displaying information in an application according to an embodiment of the present disclosure. As shown in FIG. 7, the system includes an interaction object 701 and a sharing platform 300.

The sharing platform 300 is configured to provide a data standard, so that the interaction object generates to-be-displayed information based on the data standard. The data standard indicates a field required to be displayed in the to-be-displayed information.

The sharing platform 300 is configured to provide the to-be-displayed information to the interaction object according to a display request sent by the interaction object. The display request includes an identifier of the to-be-displayed information.

In an implementation, the sharing platform includes a data management module and a display carrier. The implementation of the data management module and the display carrier may refer to the relevant description of the embodiment shown in FIG. 3.

In an implementation, the data management module interacts with the interaction object. When the interaction object is the display application, the interaction between the data management module and the interaction object may be with reference to the relevant description of the embodiments shown in FIG. 3 and FIG. 5. When the interaction object is the provider application, the interaction between the data management module and the interaction object may be with reference to the relevant description of the embodiments shown in FIG. 3 and FIG. 6.

In an implementation, the data management module is further configured to store to-be-displayed information. Implementation of the data management module may refer to relevant description in the embodiment shown in FIG. 3.

In an implementation, the display carrier is configured to display the to-be-displayed information at a preset position of the interaction object based on loading of the interaction object. Implementation of the display carrier may refer to the embodiment shown in FIG. 3 or FIG. 5.

In an implementation, when the to-be-displayed information changes, the data management module is further configured to receive a notification message sent by the interaction object. The notification message includes an identifier. Implementation of the data management module may refer to the relevant description in the embodiment shown in FIG. 6.

In an implementation, the data management module is further configured to determine whether the to-be-displayed information corresponding to the identifier is in a presented status, and send an updating message to the display carrier in response to the to-be-displayed information corresponding to the identifier being in the presented status. The updating message includes the identifier. The display carrier is configured to call back updated to-be-displayed information and display the updated to-be-displayed information to the interaction object. Implementations of the data management module and the display carrier may refer to the relevant description in the embodiment shown in FIG. 3 or FIG. 5.

In an implementation, the interaction object is a provider application 7011 or a display application 7012. The display application is configured to display the to-be-displayed information. The provider application is configured to provide the to-be-displayed information.

It can be seen from the above that the provider application creates the transferable to-be-displayed information through the data standard provided by the sharing platform, and provides the to-be-displayed information to the sharing platform. When an application (the display application) desires to display information from other application (the provider application), the display application sends a display request to the sharing platform. The display request includes an identifier of the to-be-displayed information. The sharing platform, after receiving the display request, obtains the to-be-displayed information according to the identifier in the display request, so that the display application displays the to-be-displayed information. With the technical solutions according to the embodiments of the present disclosure, in the case that there are multiple display applications, the to-be-displayed information provided by the provider application can be displayed without data communication negotiation between each of the multiple display applications and the provider application, which reduces the resources occupied by the communication negotiation and improves the efficiency of information interaction.

### Device Embodiment

Based on the above method embodiments, a device for displaying information in an application is provided according to an embodiment of the present disclosure. The device is described below in combination with the drawings.

Reference is made to FIG. 8, which is a structural diagram of a device for displaying information in an application according to an embodiment of the present disclosure. The device 800 is capable of realizing the function of the sharing platform. The device includes a receiving unit 801 and an obtaining unit 802.

The receiving unit 801 is configured to receive a display request sent by a display application. The display request includes an identifier of to-be-displayed information. The to-be-displayed information is generated by a provider application based on a data standard of the sharing platform, and the data standard indicates a field to be displayed in the to-be-displayed information.

The obtaining unit 802 is configured to obtain the to-be-displayed information according to the identifier.

In an implementation, the obtaining unit 802 is configured to search out and obtain the to-be-displayed information locally according to the identifier. Alternatively, the obtaining unit 802 is configured to send a request message for obtaining the to-be-displayed information to the provider application according to the identifier, and receive a response message sent by the provider application, where the response message includes the to-be-displayed information.

In an implementation, the device further includes a providing unit (not shown in the drawings).

The providing unit is configured to provide a display carrier for the display application in response to the display application loading of the device, to display the to-be-displayed information through the display carrier on the display application.

In an implementation, there is a display component corresponding to the to-be-displayed information. The display component indicates a way for displaying the to-be-displayed information.

In an implementation, the display carrier provided by the device is configured to provide an operating environment for the display component.

In an implementation, the receiving unit 801 is further configured to receive a notification message sent by the provider application when the to-be-displayed information corresponding to the identifier changes. The notification message includes the identifier.

In an implementation, the notification information further includes updated to-be-displayed information.

In an implementation, the device further includes a determination unit (not shown in the drawings).

The determination unit is configured to determine whether the to-be-displayed information corresponding to the identifier is in a presented status, after the notification message is received.

The obtaining unit 802 is further configured to obtain the updated to-be-displayed information in response to the to-be-displayed information corresponding to the identifier being in the presented status, to display the updated to-be-displayed information by the display application.

In an implementation, the device further includes a storage unit (not shown in the drawings).

The storage unit is configured to store the updated to-be-displayed information locally.

In an implementation, the data standard indicates a type corresponding to the field.

It should be noted that implementations of the units in this embodiment may refer to the relevant description of the sharing platform in the above method embodiment, which is not repeated here in this embodiment.

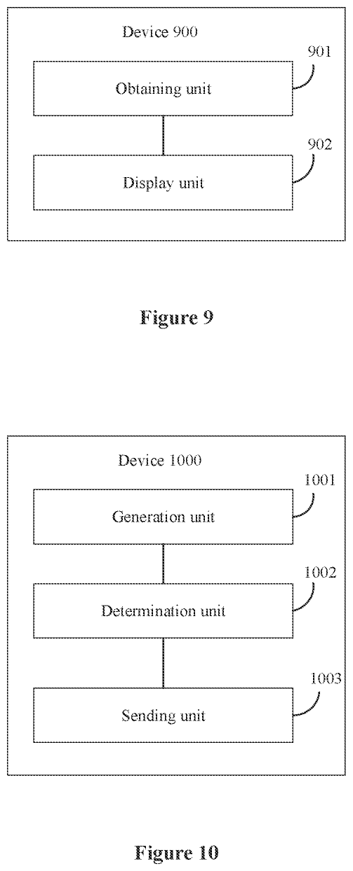

Reference is made to FIG. 9, which is a structural diagram of a device for displaying information in an application according to another embodiment of the present disclosure. The device is capable of realizing a function of a display application. The device includes an obtaining unit 901 and a display unit 902.

The obtaining unit 901 is configured to obtain to-be-displayed information through a sharing platform, in response to a triggering operation of the user. The to-be-displayed information is generated by a provider application based on a data standard of the sharing platform. The data standard indicates a field required to be displayed in the to-be-displayed information.

The display unit 902 is configured to display the to-be-displayed information.

In an implementation, the obtaining unit 901 is configured to send a display request to the sharing platform where the display request includes an identifier of the to-be-displayed information, and the sharing platform searches out the to-be-displayed information locally according to the identifier of the to-be-displayed information, or requests the to-be-displayed information from the provider application.

In an implementation, the display unit 902 is configured to display the to-be-displayed information according to a display component corresponding to the to-be-displayed information. The display component is configured to indicate a way for displaying the to-be-displayed information, and the display component is provided by the provider application.

In an implementation, the display unit 902 is configured to load a display carrier and display the to-be-displayed information based on the display carrier. The display carrier is provided by the sharing platform and is configured to display the to-be-displayed information.

In an implementation, the to-be-displayed information has an expansion capability, and the expansion capability indicates an operation that is available for the to-be-displayed information by the user.

In an implementation, the extension capability is coupled with the display application.

In an implementation, the expansion capability is decoupled from the display application.

In an implementation, the device further includes an output unit (not shown in the drawings).

The output unit is configured to output an extension control corresponding to the extension capability or an extension result corresponding to the extension capability, in response to a triggering operation of the user for the to-be-displayed information.

In an implementation, the extension capability includes a capability of adding a label to the to-be-displayed information or a capability of commenting on the to-be-displayed information.

In an implementation, the device further includes a jumping unit and an adding unit.

The jumping unit is configured to enter a label adding page in response to a triggering operation of the user on a label control of the to-be-displayed information.

The adding unit is configured to receive label information inputted by the user on the label adding page, and display the to-be-displayed information and added label information in an association manner.

In an implementation, the device further includes: a jumping unit and an adding unit.

The jump unit is configured to enter a comment page in response to a triggering operation of the user on a comment control of the to-be-displayed information.

The adding unit is configured to receive comment content inputted by the user on the comment page, and display the to-be-displayed information and the comment content in an association manner.

It should be noted that implementations of the units in this embodiment may refer to the relevant description of the display application, which is not repeated here in this embodiment.

Reference is made to FIG. 10, which is a structural diagram of a device for displaying information in an application according to another embodiment of the present disclosure. The device is capable of realizing a function of a provider application. The device includes a generation unit 1001, a determination unit 1002 and a sending unit 1003.

The generating unit 1001 is configured to generate to-be-displayed information based on a data standard provided by a sharing platform. The data standard indicates a field required to be displayed in the to-be-displayed information.

The determination unit 1002 is configured to determine whether to cache the to-be-displayed information on the sharing platform.

The sending unit 1003 is configured to send the to-be-displayed information to the sharing platform after determining to cache the to-be-displayed information on the sharing platform.

In an implementation, the device further includes an encapsulation unit (not shown in the drawings).

The encapsulation unit is configured to encapsulate an expansion capability for the to-be-displayed information.

In an implementation, the extension capability is coupled with the display application.

In an implementation, the expansion capability is decoupled from the display application.

In an implementation, the device stores a correspondence between the expansion capability and the display application.

It should be noted that implementations of the units in this embodiment may refer to the relevant description of the provider application, which is not repeated here in this embodiment.

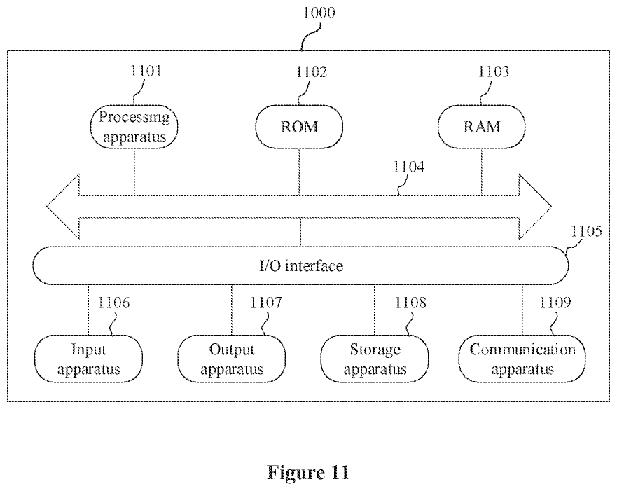

Reference is made to FIG. 11, which is a schematic structural diagram of an electronic device 1100 (for example, a terminal device or a server in FIG. 11) suitable for implementing the embodiments of the present disclosure. The terminal device according to the embodiments of the present disclosure includes but is not limited to mobile terminals such as a mobile phone, a laptop computer, a digital broadcast receiver, a PDA (personal digital assistant), a PAD (tablet computer), a PMP (portable multimedia player), and a vehicle terminal (for example, a vehicle navigation terminal), and fixed terminals such as a digital TV and a desk computer. The electronic device shown in FIG. 11 is schematic, and is not intended to limit functions and the scope of the embodiments of the present disclosure.

As shown in FIG. 11, the electronic device 1100 may include a processing apparatus 1101 (such as a central processing unit or a graphics processor), which may execute various operations and processing based on a program stored in a read only memory (ROM) 1102 or a program loaded from a storage 1108 into a random access memory (RAM) 1103. The RAM 1103 is further configured to store various programs and data required by the electronic device 1100. The processing apparatus 1101, the ROM 1102, and the RAM 1103 are connected to each other through a bus 1104. An input/output (I/O) interface 1105 is also connected to the bus 1104.

Normally, an input apparatus 1106 such as a touch screen, a touchpad, a keyboard, a mouse, a camera, a microphone, an accelerometer, and a gyroscope; an output apparatus 1107, such as a liquid crystal display (LCD), a speaker, and a vibrator; a storage apparatus 1008, such as a magnetic tape, and a hard disk; and a communication apparatus 1109 may be connected to the I/O interface 1105. The communication apparatus 1109 enables the electronic device 1100 to perform wireless or wired communication with other devices for data exchanging. Although FIG. 11 shows an electronic device 1100 including various components, it should be understood that the illustrated components are unnecessarily required to all be implemented or embodied. Alternatively, more or fewer components may be implemented or included.

According to the embodiments of the present disclosure, a process described with reference to the flowchart may be implemented by a computer software program. For example, a computer program product is further provided according to an embodiment of the present disclosure. The computer program product includes a computer program carried on a non-transitory computer-readable medium. The computer program includes program codes for performing the method shown in the flowchart. In the embodiment, the computer program may be downloaded and installed from the network via the communication apparatus 1109, or installed from the storage apparatus 1108, or installed from the ROM 1102. When the computer program is executed by the processing apparatus 1101, the functions defined in the method according to the embodiments of the present disclosure are performed.

The electronic device according to the embodiments of the present disclosure and the method for displaying information in an application according to the above embodiments belong to a same inventive concept. For the technical details not described in detail in this embodiment, reference may be made to the embodiments described above. Moreover, this embodiment has the same beneficial effects as the embodiments described above.

A computer storage medium having a computer program stored thereon is provided according to an embodiment of the present disclosure. The program, when being executed by a processor, implements the method for displaying information in an application according to the above embodiments.

It should be noted that the computer-readable medium according to the present disclosure may be a computer-readable storage medium, a computer-readable signal medium, or any combination thereof. For example, the computer-readable storage medium may be, but not limited to, an electronic, magnetic, optical, electromagnetic, infrared, or semiconductor system, apparatus, or device, or any combination of the above. More specific examples of the computer-readable storage medium include but is not limited to: electrical connections having at least one wire, a portable computer disk, a hard disk, a random access memory (RAM), a read only memory (ROM), an electrically erasable programmable read-only memory (EPROM or a flash memory), an optical fiber, a compact disc read-only memory (CD-ROM), a light storage device, a magnetic storage device, or any suitable combination of the above. In the present disclosure, the computer-readable storage medium may be any physical medium that contain or store programs. The programs may be used by an instruction execution system, an instruction execution apparatus or an instruction execution device or may be used in combination with the instruction execution system, the instruction execution apparatus and the instruction execution device. The computer-readable signal medium may include a data signal carrying computer-readable program codes which are transmitted in a baseband or transmitted as a part of carrier. The transmitted data signal may has a variety of forms including, but not limited to, electromagnetic signals, optical signals, or any suitable combination of the foregoing. The computer-readable signal medium may also be any other computer-readable medium except for the computer-readable storage medium. The computer-readable medium can send, transmit or transfer programs configured to be used by an instruction execution system, an instruction execution apparatus and an instruction execution device or used in combination with the instruction execution system, the instruction execution apparatus and the instruction execution device. The program codes included in the computer-readable medium may be transferred by any proper medium including, but not limited to, wireless, electric wire, optical cable, RF (radio frequency) and any proper combination of the above.

In some embodiments, a client and a server may perform communication by using any known network protocol such as HTTP (hyper text transfer protocol) or any network protocol to be developed in the further, and may be connected to digital data communication (for example, a communication network) in any form or carried on any medium. An example of the communication network includes a local area network (LAN), a wide area network (WAN), the Internet (e.g., the Internet), a peer-to-peer network (for example, an ad hoc peer-to-peer network), and any known network or any network to be developed in the further.

The computer-readable medium may be incorporated in the electronic device, or may exist alone without being assembled into the electronic device.

The above-described computer-readable medium carries one or more programs. The one or more programs, when executed by the electronic device, cause the electronic device to perform steps of: receiving, by a sharing platform, a display request sent by a display application, where the display request includes an identifier of to-be-displayed information, the to-be-displayed information is generated by a provider application based on a data standard of the sharing platform, and the data standard indicates a field to be displayed in the to-be-displayed information; and obtaining, by the sharing platform, the to-be-displayed information according to the identifier; or

cause the electronic device to perform steps of: obtaining, by a display application, to-be-displayed information through a sharing platform in response to a triggering operation of a user, where the to-be-displayed information is generated by the provider application based on a data standard of the sharing platform, and the data standard indicates a field to be displayed in the to-be-displayed information; and displaying, by the display application, the to-be-displayed information; or

cause the electronic device to perform steps of: generating, by the provider application, to-be-displayed information based on a data standard provided by a sharing platform, where the data standard indicates a field to be displayed in the to-be-displayed information; determining, by the provider application, whether to cache the to-be-displayed information on the sharing platform; and sending, by the provider application, the to-be-displayed information to the sharing platform after determining to cache the to-be-displayed information on the sharing platform.

The computer program codes for performing the operations according to the present disclosure may be written in one or more programming languages or the combination of the one or more programming languages. The programming language includes object oriented programming language such as Java, Smalltalk, C++ and conventional procedural programming languages such as “C” programming language or programming languages similar to “C” programming language. The program codes may be completely executed on a user computer, partially executed on the user computer, executed as a standalone software package, partially executed on the user computer and partially executed on a remote computer, completely executed on the remote computer or a server. In the cases relating to the remote computer, the remote computer may be connected to the user computer via any kind of networks including Local Area Network (LAN) or Wide Area Network (WAN), or the remote computer may be connected to an external computer (for example, via Internet provided by an Internet service provider).

Flowcharts and block diagrams in the drawings illustrate the architecture, functions and operations that can be implemented by the system, method and computer program produce according to the embodiments of the present disclosure. Each block in the flowcharts or the block diagrams may represent a part, of a module, a program section or codes, including one or more executable instructions for implementing specified logic functions. It should be noted that, in some alternative implementations, the functions marked in blocks may be performed in an order different from the order shown in the drawings. For example, two blocks shown in succession may actually be executed in parallel, or sometimes may be executed in a reverse order, which depends on the functions involved. It should also be noted that each of the block in the block diagrams and/or the flowcharts and a combination of the blocks in the block diagram and/or the flowcharts may be implemented by a dedicated hardware-based system that performs specified functions or operations, or may be realized by a combination of dedicated hardware and computer instructions.

Units involved in the embodiments of the present disclosure may be implemented by software or hardware. In some circumstances, name of a unit/module does not constitute a limitation on the unit itself.

The functions described herein above may be performed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD) and the like.

In the context of the present disclosure, the machine-readable medium may be a tangible medium that may contain or store a program, and the program may be used by or in combination with an instruction execution system, apparatus or device. The machine-readable medium may be a machine-readable signal medium or a machine-readable storage medium. The computer-readable medium may include, but is not limited to, a system, an apparatus, or a device in an electronic, magnetic, optical, electromagnetic, infrared, or semi-conductive form, or any suitable combination thereof. More specific examples of the machine-readable storage medium may include, electrical connections based on one or more wires, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device or any suitable combination thereof.

It should be noted that embodiments in this specification are described in a progressive manner. Each of the embodiments focuses on differences with other embodiments, and the same and similar parts of the embodiments may be with reference to each other. Description of the system and apparatus disclosed in the embodiments is brief, as the system and apparatus correspond to the method disclosed in the embodiments. Reference may be made to corresponding description of the method for details of the system and the apparatus.

It should be understood that in the present disclosure, the term “at least one” refers to a quantity of one or more, and the term “multiple” refers to a quantity of two or more. The term “and/or” is used to describe an association of objects, and indicates three possible associations. For example, “A and/or B” may indicate a case of merely A, a case of merely B, and a case of both A and B, where A and B may be in a singular form or a plural form. The symbol “/” generally indicates an “or” relationship between related objects. The expression “at least one of . . . ” or a similar expression refers to “any combination of . . . ”, including any combination consisting of a single item or multiple items. For example, “at least one of a, b, or c” may indicate: “a”, “b”, “c”, “a and b”, “a and c”, “b and c”, or “a, b, and c”, where a, b, and c may be in a singular form or a plural form.

It should be further noted that relational terms, such as first and second, in the present disclosure are only used to distinguish one entity or operation from another entity or operation and does not necessarily require or imply any actual relationship or order between these entities or operations. Moreover, terms “comprising”, “including”, or any other variant thereof are intended to encompass a non-exclusive inclusion such that a process, a method, an articles, or a device that include a series of elements include not only those elements but also those that are not explicitly listed or other elements that are inherent to such process, method, article, or device. The expression “comprising a(n)” in which an element is defined will not preclude presence of an additional identical element(s) in a process, method, article or device comprising the defined element(s)” unless further defined.

The steps of the method or algorithm described in combination with the embodiments disclosed herein may be directly implemented by hardware, a software module executed by a processor, or a combination thereof. The software module may be arranged in a random access memory (RAM), an internal memory, a read only memory (ROM), an electrically programmable ROM, an electrically-erasable programmable ROM, a register, a hard disk, a removable disk drive, a CD-ROM, or any other storage medium known in the art.

With the above description of the disclosed embodiments, those skilled in the art can implement or use the present disclosure. Various modifications to the embodiments are obvious to the person skilled in the art, and general principles defined in the present disclosure may be implemented in other embodiments without departing from the spirit or scope of the present disclosure. Therefore, the present application shall not be limited to the embodiments described herein but have the widest scope that complies with the principle and novelty disclosed in this specification.

1. A method for displaying information in an application, comprising:
receiving, by a sharing platform, a display request sent by a display application, wherein the display request comprises an identifier of to-be-displayed information, the to-be-displayed information is generated by a provider application based on a data standard of the sharing platform, and the data standard indicates a field to be displayed in the to-be-displayed information; and
obtaining, by the sharing platform, the to-be-displayed information according to the identifier.

2. The method according to claim 1, wherein the obtaining, by the sharing platform, the to-be-displayed information according to the identifier comprises:
searching out and obtaining, by the sharing platform, the to-be-displayed information locally according to the identifier; or
sending, by the sharing platform, a request message for obtaining the to-be-displayed information to the provider application according to the identifier; and receiving, by the sharing platform, a response message sent by the provider application, wherein the response message comprises the to-be-displayed information.

3. The method according to claim 1, further comprising:
providing, by the sharing platform, a display carrier to the display application in response to the display application loading the sharing platform, to display the to-be-displayed information through the display carrier on the display application.

4. The method according to claim 1, wherein a display component corresponding to the to-be-displayed information is provided, and the display component indicates a way for displaying the to-be-displayed information.

5. The method according to claim 4, wherein the display carrier provided by the sharing platform is configured to provide an operating environment for the display component.

6. The method according to claim 1, further comprising:
receiving, by the sharing platform, a notification message sent by the provider application, in a case that the to-be-displayed information corresponding to the identifier changes, wherein the notification message comprises the identifier.

7. The method according to claim 6, wherein the notification message further comprises updated to-be-displayed information.

8. The method according to claim 6, wherein after the sharing platform receives the notification message, the method further comprises at least one of:
determining, by the sharing platform, whether the to-be-displayed information corresponding to the identifier is in a presented status; and
obtaining, by the sharing platform, the updated to-be-displayed information in response to the to-be-displayed information corresponding to the identifier being in the presented status, to display the updated to-be-displayed information by the display application; or
storing, by the sharing platform, the updated to-be-displayed information locally.

9. (canceled)

10. The method according to claim 1, wherein the data standard indicates a type corresponding to the field.

11. A method for displaying information in an application, comprising:
obtaining, by a display application, to-be-displayed information through a sharing platform in response to a triggering operation of a user, wherein the to-be-displayed information is generated by the provider application based on a data standard of the sharing platform, and the data standard indicates a field to be displayed in the to-be-displayed information; and
displaying, by the display application, the to-be-displayed information.

12. The method according to claim 11, wherein the obtaining, by a display application, to-be-displayed information through a sharing platform comprises:
sending, by the display application, a display request to the sharing platform, wherein the display request comprises an identifier of the to-be-displayed information, to cause the sharing platform to search out the to-be-displayed information locally or to request the to-be-displayed information from the provider application according to the identifier of the to-be-displayed information.

13. The method according to claim 11, wherein the displaying, by the display application, the to-be-displayed information comprises:
displaying, by the display application, the to-be-displayed information according to a display component corresponding to the to-be-displayed information, wherein the display component indicates a way for displaying the to-be-displayed information, and the display component is provided by the provider application.

14. The method according to claim 11, wherein the displaying, by the display application, the to-be-displayed information comprises:
loading, by the display application, a display carrier; and displaying, by the display application, the to-be-displayed information based on the display carrier, wherein the display carrier is provided by the sharing platform and is configured to display the to-be-displayed information.

15. The method according to claim 11, wherein the to-be-displayed information has an expansion capability, and the expansion capability indicates an operation which is available for the to-be-displayed information by the user.

16. (canceled)

17. (canceled)

18. The method according to claim 15, further comprising:
outputting, by the display application, an extension control corresponding to the extension capability or an extension result corresponding to the extension capability, in response to a triggering operation of the user for the to-be-displayed information.

19. The method according to claim 15, wherein the extension capability indicates a capability of adding a label to the to-be-displayed information or a capability of commenting on the to-be-displayed information.

20. The method according to claim 19, further comprising:
entering a label adding page, in response to a triggering operation of the user on a label control of the to-be-displayed information; and
receiving, by the display application, label information inputted by the user on the label adding page; and displaying, by the display application, the to-be-displayed information and the added label information in an association manner; or
entering a comment page, in response to a triggering operation of the user on a comment control of the to-be-displayed information; and receiving, by the display application, comment content inputted by the user on the comment page; and displaying, by the display application, the to-be-displayed information and the comment content in an association manner.

21. (canceled)

22. A method for displaying information in an application, comprising:
generating, by the provider application, to-be-displayed information based on a data standard provided by a sharing platform, wherein the data standard indicates a field to be displayed in the to-be-displayed information;
determining, by the provider application, whether to cache the to-be-displayed information on the sharing platform; and
sending, by the provider application, the to-be-displayed information to the sharing platform in response to determining to cache the to-be-displayed information on the sharing platform.

23. The method according to claim 22, wherein after the generating, by the provider application, to-be-displayed information based on a data standard provided by a sharing platform, the method further comprises:
encapsulating, by the provider application, an expansion capability for the to-be-displayed information.

24. (canceled)

25. (canceled)

26. The method according to claim 22, wherein the provider application stores a correspondence between the expansion capability and the display application.

27. A system for displaying information in an application, comprising an interaction object and a sharing platform, wherein
the sharing platform is configured to provide a data standard, to cause the interaction object to generate to-be-displayed information based on the data standard, wherein the data standard indicates a field to be displayed in the to-be-displayed information; and
the sharing platform is further configured to provide the to-be-displayed information to the interaction object according to a display request sent by the interaction object, wherein the display request comprises an identifier of the to-be-displayed information.

28. The system according to claim 27, wherein the sharing platform comprises a data management module and a display carrier, and
wherein the data management module interacts with the interaction object.

29. (canceled)

30. The system according to claim 28, wherein the data management module is further configured to store the to-be-displayed information.

31. The system according to claim 28, wherein the display carrier is configured to display the to-be-displayed information at a preset position of the interaction object based on loading of the interaction object.

32. The system according to claim 28, wherein in a case that the to-be-displayed information changes, the data management module is further configured to receive a notification message sent by the interaction object, wherein the notification message comprises the identifier.

33. The system according to claim 32, wherein
the data management module is further configured to determine whether to-be-displayed information corresponding to the identifier is in a presented status, and send an updating message to the display carrier in response to the to-be-displayed information corresponding to the identifier being in the presented status, wherein the updating message comprises the identifier; and
the display carrier is configured to call back updated to-be-displayed information and display the updated to-be-displayed information to the interaction object.

34. The system according to claim 27, wherein the interaction object is a display application or a provider application, the display application is configured to display the to-be-displayed information, and the provider application is configured to provide the to-be-displayed information.

35-40. (canceled)
